(19) United States
(12) Patent Application Publication
(10) Pub. No.: US 2018/0283056 A1
(43) Pub. Date: Oct. 4, 2018

(54) METHOD OF PREVENTING UNINTENDED ACTIONS ASSOCIATED WITH AN INPUT DEVICE OF A VEHICLE

(71) Applicant: FORD GLOBAL TECHNOLOGIES, LLC, Dearborn, MI (US)

(72) Inventors: Howard Paul Tsvi Linden, Southfield, MI (US); Onoyom Essien Ekanem, White Lake, MI (US); Cornel Lewis Gardner, Romulus, MI (US)

(21) Appl. No.: 15/472,392

(22) Filed: Mar. 29, 2017

(51) Int. Cl. E05B 77/54; G07C 9/00; E05B 81/64

(52) U.S. Cl. CPC E05B 77/54; G07C 2009/00761; E05B 81/64; G07C 9/00182

(57) ABSTRACT

A method of preventing unintended actions associated with an input device accessible from an exterior of a vehicle includes the steps of: (a) monitoring a state of switches associated with keys of said keypad; (b) identifying an action associated with the state of said switches associated with said keys of said keypad; (c) determining a state of at least one component of the vehicle other than said keypad; and (d) precluding the action associated with the state of said switches associated with said keys of said keypad based on the determined state of said at least one component of the vehicle. In one embodiment, a processor associated with the keypad performs the steps of monitoring, identifying, determining, and precluding and the action may be locking a closure member of the vehicle.

### TECHNICAL FIELD

This document relates generally to external input devices of a vehicle, and more specifically to a method of preventing unintended actions associated with such input devices.

### BACKGROUND

It is well known to utilize an input device positioned on an exterior of a vehicle to provide keyless entry to the vehicle. The input device may be a keypad including a group of capacitive switches for example. Engagement of the switches sends a signal to a control module of the vehicle to take a desired action (e.g., locking/unlocking the doors). Under certain conditions, however, these unintelligent keypads may send signals to the control module which are unintended and result in an undesired action. For instance, an input device of a vehicle travelling through a car wash may be activated resulting in the undesired action of locking the vehicle, or possibly releasing a rear hatch.

In order to overcome such undesired actions, vehicle manufacturers have deployed switches (e.g., a car wash switch) which temporarily disable the external input device at the discretion of the vehicle operator. While such switches are intended to prevent the vehicle from reaching the end of the car wash with its doors unlocked, the switches are not fully effective and at times forgotten resulting in unnecessary inconvenience to vehicle operators.

Accordingly, a need exists for a way to prevent unintended actions associated with an input device accessible from an exterior of the vehicle. Ideally, this can be accomplished by associating intelligence with the input device to allow additional information concerning the vehicle to be considered before taking any action in response to inputs of the input device. For example, information relating to components of the vehicle may be obtained via a controller area network (CAN) of the vehicle and utilized by the added intelligence associated with the input device before taking any action. Associating intelligence with the input device also allows these actions to occur without engaging or waking up the vehicle's body control module which is more efficient and provides a quicker response.

### SUMMARY OF THE INVENTION

In accordance with the purposes and benefits described herein, a method is provided of preventing unintended actions associated with an input device accessible from an exterior of a vehicle. The method may be broadly described as comprising the steps of: monitoring the input device using a processor associated with the input device for an input; determining a state of at least one component of the vehicle other than the input device using said processor; and precluding an action resulting from the input dependent upon the state of the at least one component of the vehicle.

In another possible embodiment, the at least one component of the vehicle includes at least one of a latching brake, a transmission, and at least one wheel.

In yet another possible embodiment, the action resulting from the input is precluded if the state of one of a drive gear, a neutral gear, or a reverse gear of the transmission is engaged. In another, the action resulting from the input is precluded if the state of a park gear of the transmission is unengaged.

In still another possible embodiment, the method further includes the step of reading information concerning the state of said at least one component of the vehicle via a controller area network.

In one other possible embodiment, the processor associated with the input device performs the step of precluding.

In still yet another possible embodiment, the precluding step includes the step of preventing said processor from sending any instruction for taking an action responsive to the input.

Another possible method of preventing unintended actions associated with a keypad accessible from an exterior of a vehicle may be broadly described as comprising the steps of: monitoring a state of switches associated with keys of said keypad; identifying an action associated with the state of said switches associated with said keys of said keypad; determining a state of at least one component of the vehicle other than said keypad; and precluding the action associated with the state of said switches associated with said keys of said keypad based on the determined state of said at least one component of the vehicle.

In another possible embodiment, a processor associated with the keypad performs the step of monitoring, identifying, determining, and precluding.

In one other possible embodiment, the action is locking a closure member of the vehicle and the action is precluded if the determined state of a latching brake is unengaged. In yet another possible embodiment, the action is locking a closure member of the vehicle and the action is precluded if the determined state of a drive gear, a reverse gear, or a neutral gear of a transmission is engaged. In other embodiments, the closure member includes one of a door, a hatch back, or a trunk.

In still another possible embodiment, the action is locking a closure member of the vehicle and the action is precluded if the determined state of a wheel is rotating.

In another possible embodiment, the method further includes the step of determining whether a transmission of the vehicle is a manual transmission or an automatic transmission, and if the at least one component of the vehicle is a latching brake if the transmission is determined to be a manual transmission and a drive gear if the transmission is determined to be an automatic transmission.

In yet another possible embodiment, the step of reading information concerning the state of said at least one component of the vehicle via a controller area network.

In one possible embodiment, a circuit for preventing unintended actions associated with an input device accessible from an exterior of a vehicle may be broadly described as comprising a a processor associated with the input device, and a controller area network interconnecting the processor and at least one component of the vehicle, wherein the processor obtains information relating to the state of the at least one component of the vehicle, other than said input device, via the controller area network and determines, dependent upon the state of the at least one component of the vehicle, whether to send an instruction for taking an action responsive to an input of the input device.

In another possible embodiment, the input device is a keypad. In still another, the keypad includes at least one switch, the processor monitors a state of the at least one switch and identifies an action associated with the state of the at least one switch.

In still another possible embodiment, the processor determines a state of at least one component of the vehicle, and precludes the action associated with the state of the at least one switch based on the determined state of the at least one component of the vehicle.

In other possible embodiments, the circuits for preventing unintended actions associated with an input device accessible from an exterior of a vehicle described above are incorporated into a vehicle.

In the following description, there are shown and described several embodiments of a method of preventing unintended actions associated with an input device accessible from an exterior of a vehicle and a related circuit. As it should be realized, the methods and circuits are capable of other, different embodiments and their several details are capable of modification in various, obvious aspects all without departing from the methods and assemblies as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the vehicle, circuits, and methods and together with the description serve to explain certain principles thereof. In the drawing figures:

FIG. 1 is an exemplary illustration of a vehicle in perspective view;

FIG. 2 is an illustration of an input device located external to a pillar of the vehicle;

FIG. 3 is a block diagram of an exemplary circuit for preventing unintended actions associated with an input device accessible from an exterior of a vehicle; and

FIG. 4 is a flow chart schematic for preventing unintended actions associated with an input device accessible from an exterior of a vehicle.

Reference will now be made in detail to the present preferred embodiments of the method of preventing unintended actions associated with an input device accessible from an exterior of a vehicle and related circuits, examples of which are illustrated in the accompanying drawing figures, wherein like numerals are used to represent like elements.

### DETAILED DESCRIPTION

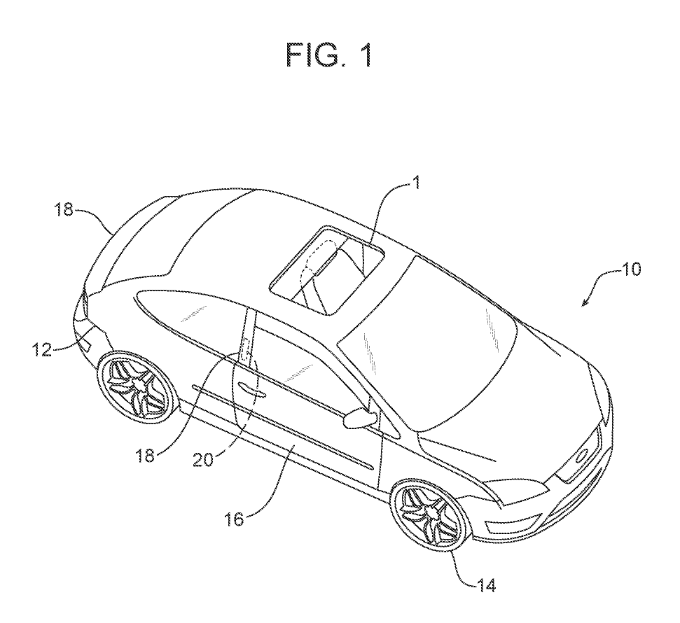

As shown in FIG. 1, an automotive passenger vehicle 10 is generally illustrated having a body 12, wheels 14, and a plurality of closure members. The closure members may include doors 16, a hatch back 18, or a trunk (not shown) depending on the vehicle. As is known in the art, the closure members are each provided with a locking feature (e.g., door locks) that prevents those other than the vehicle owner/operator from accessing an interior of the vehicle 10. In the described embodiment, the vehicle 10 includes an input device 20 for controlling at least the door locks 22.

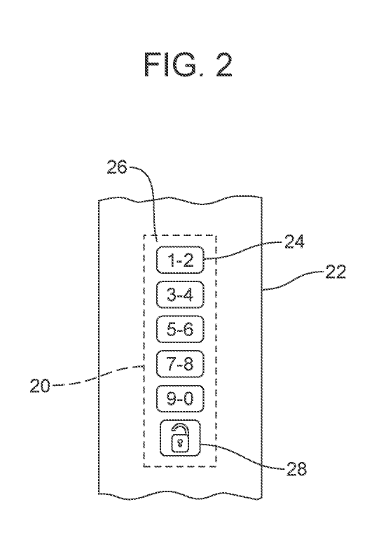

In the described embodiment, the input device 20 is located external to the vehicle 10 along a B-pillar 22 and includes a series of five number group buttons 24 as shown in FIG. 2. The number groups 24 are illuminated upon contact of an outer surface 26 of the input device 20. Typically, such contact occurs when the vehicle owner approaches the vehicle to unlock the doors 16 to gain entry. Alternatively, the vehicle owner may contact the outer surface of the input device 20 to lock the vehicle doors 16. Both locking and unlocking of the vehicle doors 16 may occur through inputting a code (e.g., a four digit number) into the input device 20. In another embodiment, the input device 20 may include a lock/unlock button 28 which may be responsive to the vehicle owner's contact with the button when a keyfob (not shown) of the vehicle 10 is present, or following input of the code. In alternate embodiments, the input device 18 may be a keypad including a plurality of keys connected to a plurality of capacitive switches as is known in the art.

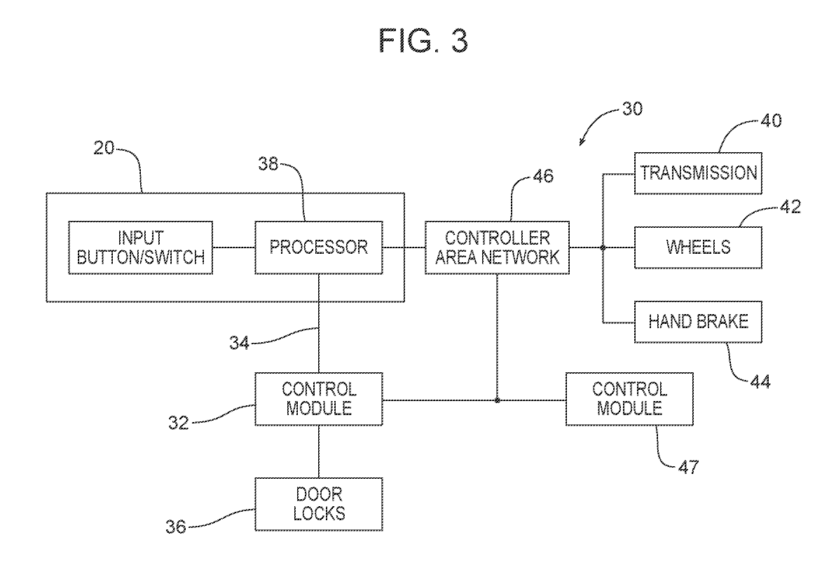

FIG. 3 illustrates a schematic diagram of an exemplary circuit 30 for preventing unintended actions associated with an input device 20, such as a keypad, accessible from an exterior of the vehicle 10. The circuit 30 includes a body control module 32 connected to the input device 20 via a local interconnect network or LIN bus 34. The body control module 32 is further connected to and controls a door lock switch 36. In other embodiments, the body control module may be connected to a trunk lock or release switch, a hatchback lock or release switch or other vehicle closure members.

In the described embodiment, the body control module 32 typically receives instructions from the input device 20 to take an action responsive to an input of the input device. Such an action may include, for example, locking or unlocking the door 16. As is known in the art, a vehicle owner may enter a code having one or more digits by contacting a series of buttons/switches (e.g., buttons 24) on an input device or contacting a lock/unlock button/switch (e.g., button 28) on the input device when a keyfob is present. Once the code is entered, an action associated with the code is taken by the body control module 32.

As noted above, however, there are certain instances where it is desirable to prevent an unintended action associated with the input device 20. For example, when the vehicle 10 is travelling through a car wash, the input device 20 remains active allowing inadvertent contact with the input device which could result in an undesired and unnecessary action occurring (e.g., locking the vehicle doors). In order to avoid such scenarios wherein it is desirable to prevent the unintended action associated with the input device 20, a processor 38 is associated with the input device 20. The processor 38 obtains information relating to a state of at least one component of the vehicle 10. This necessarily excludes information relating to the state of the input device 20.

As shown in FIG. 3, the input device 20 and processor 38 are connected to and communicate with various components of the vehicle including, for example, a transmission 40, at least one vehicle wheel 42, and a hand brake 44 via a controller area network or CAN bus 46. Another vehicle component monitored by the input device 20 and processor 38 is a control module 47 which contains specific information about the vehicle 10. This information includes, for example, information concerning the vehicle's transmission 40 or vehicle identification number and is similarly obtained by the processor 38 via the CAN bus 46.

In the described embodiment, the processor 38 is a microprocessor which monitors and obtains information relating to a state of at least one component of the vehicle 10 via the CAN bus 46. Specifically, the processor 38 obtains information indicating whether the transmission 40 is a manual transmission or an automatic transmission from control module 47. In addition, the processor 38 obtains information relating to a state of the transmission 40, for example, whether a drive gear or a non-drive gear is engaged. The drive gear may include a rear gear, a drive gear, a low drive gear, etc. and the non-drive gear is a neutral gear. Similarly, the processor 38 monitors at least one of the vehicles wheels 42 to determine whether the wheel is rotating. More specifically, the processor 38 monitors at least one wheel speed sensor (not shown) associated with the anti-lock braking system as is known in the art. Last, the processor 38 monitors a state of the latch brake 44 (e.g., a hand brake) to determine whether the latch brake is engaged. Any portion or all of the information concerning the state(s) of the vehicle components may be used by the processor 38 to determine, dependent upon the state(s) of the vehicle components, whether to send an instruction for taking an action responsive to an input of the input device 20. In the described embodiment, the processor 38 is determining whether to lock the doors 16.

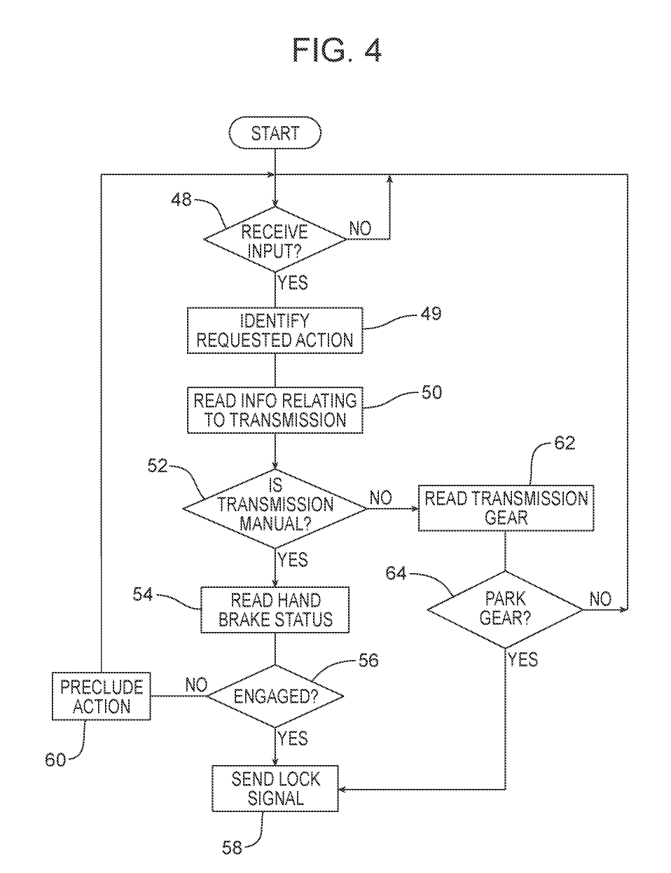

The steps utilized in one embodiment of the invention will now be described with reference to FIG. 4. FIG. 4 is a flowchart of operational control of the control circuit 30 of the vehicle 10 according to the embodiment. The processing sequence related to operational control according to the embodiment is executed by the processor 38 of the input device 20 as a program stored in memory.

The sequence is initiated upon receipt of an input at the input device 20 at Step 48. In other words, the processor 38 monitors a state of at least one button/switch of the input device 20 for an input and identifies an action associated with the state of the at least one button/switch at Step 49. Once the action is identified, information relating to the type of transmission 40 in the vehicle 10 is read or otherwise obtained at Step 50. As noted above, certain vehicle information including transmission type is typically stored in a control module 47 of the vehicle 10 which can be read or obtained by the processor 38 associated with the input device 20 via the CAN bus 46. The processor 38 determines whether the transmission 40 is a “Manual” or an “Automatic” transmission at Step 52.

If the transmission 40 is determined to be a “Manual” transmission, the processor 38 reads or obtains information concerning a state of the hand brake 44 at Step 54. If the state of the hand brake 44 is determined to be “Engaged” at Step 56, then the processor 38 sends an instruction for taking the action responsive to the input of the input device 20 at Step 58. In this instance, the processor 38 sends an instruction, or lock signal, to lock the doors 16 of the vehicle 10. If the state of the hand brake 44 is determined to be “Not Engaged” at Step 56, then the processor 38 precludes the action directed by the input at Step 60 and the sequence terminates until another input is received at the input device 20 at Step 48.

If the transmission 40 is determined to be an “Automatic” transmission at Step 52, the processor 38 reads or obtains information concerning a state of the transmission 40 at Step 62. If the state of the transmission 40 is determined to be a “Park Gear” at Step 64, then the processor 38 sends an instruction for taking an action responsive to the input of the input device 20 at Step 58. Again, in this instance, the processor 38 sends an instruction, or lock signal, to lock the doors 16 of the vehicle 10. If the state of the transmission 40 is determined not to be a “Park Gear,” for example, the transmission is in a “Neutral Gear,” a “Drive Gear,” or a “Reverse Gear” at Step 64, then the processor 38 precludes the action directed by the input at Step 60 and the sequence terminates until another input is received at the input device 20 at Step 48.

In summary, numerous benefits result from the method of preventing unintended actions associated with an input device accessible from an exterior of a vehicle as illustrated in this document. The method is capable of preventing inadvertent locking of vehicle doors for example. The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A method of preventing unintended actions associated with an input device accessible from an exterior of a vehicle, comprising the steps of:
monitoring the input device using a processor associated with the input device for an input;
determining a state of at least one component of the vehicle other than the input device using said processor; and
precluding an action directed by the input dependent upon the state of the at least one component of the vehicle.

2. The method of preventing unintended actions associated with an input device accessible from an exterior of a vehicle of claim 1, wherein said at least one component of the vehicle includes at least one of a latching brake, a transmission, and at least one wheel.

3. The method of preventing unintended actions associated with an input device accessible from an exterior of a vehicle of claim 2, wherein the action resulting from the input is precluded if the state of one of a drive gear, a neutral gear, or a reverse gear of said transmission is engaged.

4. The method of preventing unintended actions associated with an input device accessible from an exterior of a vehicle of claim 2, wherein the action resulting from the input is precluded if the state of a park gear of said transmission is unengaged.

5. The method of preventing unintended actions associated with an input device accessible from an exterior of a vehicle of claim 1, further comprising the step of reading information concerning the state of said at least one component of the vehicle via a controller area network.

6. The method of preventing unintended actions associated with an input device accessible from an exterior of a vehicle of claim 1, wherein said processor associated with the input device performs the step of precluding.

7. The method of preventing unintended actions associated with an input device accessible from an exterior of a vehicle of claim 6, wherein the precluding step includes the step of preventing said processor from sending any instruction for taking an action responsive to the input.

8. A method of preventing unintended actions associated with a keypad accessible from an exterior of a vehicle, comprising the steps of:
monitoring a state of switches associated with keys of said keypad;
identifying an action associated with the state of said switches associated with said keys of said keypad;
determining a state of at least one component of the vehicle other than said keypad; and
precluding the action associated with the state of said switches associated with said keys of said keypad based on the determined state of said at least one component of the vehicle.

9. The method of preventing unintended actions associated with a keypad accessible from an exterior of a vehicle of claim 8, wherein a processor associated with the keypad performs the steps of monitoring, identifying, determining, and precluding.

10. The method of preventing unintended actions associated with a keypad accessible from an exterior of a vehicle of claim 9, wherein the action is locking a closure member of the vehicle and the action is precluded if the determined state of a latching brake is unengaged.

11. The method of preventing unintended actions associated with a keypad accessible from an exterior of a vehicle of claim 9, wherein the action is locking a closure member of the vehicle and the action is precluded if the determined state of a drive gear, a reverse gear, or a neutral gear of a transmission is engaged.

12. The method of preventing unintended actions associated with a keypad accessible from an exterior of a vehicle of claim 11, wherein said closure member includes one of a door, a hatch back, or a trunk.

13. The method of preventing unintended actions associated with a keypad accessible from an exterior of a vehicle of claim 9, wherein the action is locking a closure member of the vehicle and the action is precluded if the determined state of a wheel is rotating.

14. The method of preventing unintended actions associated with a keypad accessible from an exterior of a vehicle of claim 9, further comprising the step of determining whether a transmission of the vehicle is a manual transmission or an automatic transmission, and wherein the at least one component of the vehicle is a latching brake if said transmission is determined to be a manual transmission and at least one of a drive gear, a neutral gear, or a reverse gear of said transmission, or at least one wheel if the transmission is determined to be an automatic transmission.

15. The method of preventing unintended actions associated with a keypad accessible from an exterior of a vehicle of claim 9, further comprising the step of reading information concerning the state of said at least one component of the vehicle via a controller area network.

16. A circuit for preventing unintended actions associated with an input device accessible from an exterior of a vehicle comprising:
a processor associated with said input device;
a controller area network interconnecting said processor and at least one component of the vehicle;
wherein said processor obtains information relating to a state of said at least one component of the vehicle, other than said input device, via said controller area network, and determines, dependent upon the state of said at least one component of the vehicle, whether to send an instruction for taking an action responsive to an input of said input device.

17. The circuit for preventing unintended actions associated with an input device accessible from an exterior of a vehicle of claim 16, wherein said input device is a keypad.

18. The circuit for preventing unintended actions associated with an input device accessible from an exterior of a vehicle of claim 17, wherein said keypad includes at least one switch, said processor monitors a state of said at least one switch and identifies the action associated with the state of said at least one switch.

19. The circuit for preventing unintended actions associated with an input device accessible from an exterior of a vehicle of claim 18, wherein said processor determines the state of said at least one component of the vehicle and precludes the action associated with the state of said at least one switch based on the determined state of said at least one component of the vehicle.

20. A vehicle incorporating the circuit for preventing unintended actions associated with an input device accessible from an exterior of the vehicle of claim 16.
